(19) United States
(12) Patent Application Publication
(10) Pub. No.: US 2026/0120016 A1
(43) Pub. Date: Apr. 30, 2026

(54) SYSTEMS FOR AND METHODS FOR DESCRIPTOR-BASED PRESENTATION AND HARMONIZATION OF FORECASTED RESOURCE DEPLOYMENT

(71) Applicant: Groundswell, McLean, VA (US)

(72) Inventors: Blake Templeman, McLean, VA (US); Meg Guckenberg, McLean, VA (US); Brad Weldon, McLean, VA (US)

(73) Assignee: Groundswell, McLean, VA (US)

(21) Appl. No.: 19/376,454

(22) Filed: Oct. 31, 2025

Related U.S. Application Data
(60) Provisional application No. 63/714,433, filed on Oct. 31, 2024.

(51) Int. Cl. G06Q 10/0631

(52) U.S. Cl. CPC G06Q 10/06312; G06Q 10/06313

(57) ABSTRACT

A data processing system may obtain a first data structure corresponding to a predicted resource deployment. The data processing system may present a plurality of predefined functional components based on the predicted resource deployment. The data processing system may generate computer-executable instructions responsive to a received selection of one or more of the predefined functional components. The data processing system may present, according to an execution of the computer-executable instructions responsive to the selection of the selected one of the predefined functional components, a plurality of control elements corresponding to a plurality of descriptors. The data processing system may generate, via the GUI a second data structure, the second data structure structured according to one or more of the plurality of descriptors.

### CROSS-REFERENCE TO RELATED APPLICATIONS

This application claims the benefit of and priority to U.S. Provisional Application No. 63/714,433, filed Oct. 31, 2024, which is hereby incorporated in its entirety for all purposes.

### TECHNICAL FIELD

This disclosure generally relates to descriptor-based presentation and reconciliation of forecasted resource allocation. For example, the presentation and reconciliation can be executed and presented in a computing system and environment implementing low-code or no-code programming and operations.

### BACKGROUND

Resources may be allocated according to periodic reviews, evaluations, or schedules. For example, a budget process can follow an annual, quarterly, or other cycle. Similarly, other resource allocations, such as allocations of computational resources, energy, or bandwidth may conform to such a cycle. In some circumstances, priorities, resources, or demands may be adjusted subsequent to initial allocation. For example, subsequent to establishing a federal budget, emergent priorities, such as public health crises or military operations can adjust resources. Such adjustments include reallocation, supplementation, sequestration, or so forth. With (or absent) changes to budgets, spending on newly prioritized or emergent issues may be difficult to track. For example, public health crises may be associated with spending outlays from various organizations and line items. Insight into such allocations is frequently requested, but can be difficult to achieve, particularly, when a category may not have been contemplated during a prior stage in resource allocation operations (e.g., previous budgetary operations).

Despite the widespread need for flexible resource deployment, existing technological solutions often suffer from significant shortcomings. Conventional systems for resource allocation and recourse management typically rely on rigid, pre-defined structures and cycles. These systems are not well-equipped to accommodate rapid or unanticipated changes in priorities, which may arise due to unforeseen events like natural disasters, public health emergencies, or geopolitical shifts. As a result, tracking the flow of resources in response to emergent needs can be slow, fragmented, or incomplete.

### SUMMARY

According to aspects of the present disclosure, a data processing system can interface with various data sources and provide various instances of a user interface for a budget management or other resource deployment function, which may include a graphical user interface (GUI) among other forms of user interface. The user interface may be implemented according to a low code or no code programming environment, such that views or operations indicated by user configuration inputs may be readily implemented as software programming operations and, in some cases, modified by end-users or local support responsive to emergent use cases. For example, the user interface can be configured to generate one or more views to modulate other of the views. In some implementations of the present disclosure, tags or other descriptors may be associated with various data items, as may be used to adjust data flows or reporting functions of the data processing system. Such tags may aid responses to changing priorities such as by capturing data used for subsequent reporting, supplemental resource deployment or sequestration, or other adjustments to a forecasted or other predicted resource deployment. In some embodiments, multiple instances of the data processing system are configured to interface with one another as may aid resource deployment adjustments. Such adjustments can include, for example, budgetary adjustments between or within agencies, or as may aid reconciliation between other entities such as between state and federal governments or portions thereof.

Embodiments included herein relate to computing systems and a computer-implemented method for automatic generation of computer executable code in a computing environment for performing processor-executed operations. The system components may include one or more computing devices having at least one processor, and software programming for a graphical user interface (GUI) and predefined functional components actuatable to generate computer-executable instructions. The operations of the computer-implemented method may include: obtaining a first data structure corresponding to a forecasted or other predicted resource deployment; presenting a plurality of predefined functional components based on the forecasted or other predicted resource deployment; generating computer-executable instructions responsive to a received selection of one or more of the predefined functional components; presenting, according to an execution of the computer-executable instructions responsive to the selection of the selected one of the predefined functional components, a plurality of control elements corresponding to a plurality of descriptors; and generating, via the GUI a second data structure, the second data structure structured according to one or more of the plurality of descriptors.

The resource deployment may include a first forecast corresponding to a current temporal period and a second forecast corresponding to a subsequent temporal period.

The operations may further include comparing the resource deployment with a current state of deployed resources to generate reconciliation data.

The resource deployment may correspond to a hierarchical structure including a plurality of levels. Each lower level of the plurality of levels may be aggregated at progressively higher levels of the hierarchical structure.

The operations may further include generating a data map to correlate data elements of various levels of a hierarchical structure. The data map is configured to maintain coherency between of one or more metrics between the plurality of levels.

The operations may further include retrieving, from a plurality of sources, data elements of the first data structure, via one or more application programming interfaces (APIs). The APIs may include at least one of a representational state transfer API or a simple object access protocol API.

The operations may further include reconciling the resource deployment based on at least one of a continuing resolution, sequestration, or adjustment to a resource deployment for a current or future temporal period.

The operations may further include generating a graphical depiction of resources deployment corresponding to the descriptors.

Embodiments included herein relate to a computing system. The computing system can obtain a first data structure corresponding to a predicted resource deployment and a token providing an identity of a first user. The computing system can present a subset of a plurality of predefined functional components of a no-code or low-code environment based on the predicted resource deployment and an access level associated with the first user identity. The computing system can generate executable instructions responsive to a received selection of one or more of the subset of the predefined functional components of the no-code or low-code environment. The computing system can present, according to an execution of the executable instructions responsive to the selection of the selected one of the predefined functional components, a plurality of control elements corresponding to a plurality of descriptors. The computing system can generate a second data structure, the second data structure structured according to one or more of the plurality of descriptors. The computing system can present, via the GUI, the second data structure to a plurality of second users based on a receipt of corresponding tokens for the second users, in response to identifying a first hierarchical level of the first user relative to a second hierarchical level of the plurality of second users.

In some embodiments, the predicted resource deployment comprises a first prediction corresponding to a current temporal period and a second prediction corresponding to a subsequent temporal period.

In some embodiments, the computing system can compare the predicted resource deployment with a current state of deployed resources to generate harmonization data.

In some embodiments, the predicted resource deployment corresponds to a hierarchical structure comprising a plurality of levels, wherein each of lower levels of the plurality of levels are aggregated at progressively higher levels of the hierarchical structure.

In some embodiments, the computing system can generate a data map to correlate data elements of various levels of a hierarchical structure, the data map configured to maintain coherency between one or more metrics between the plurality of levels.

In some embodiments, the computing system can retrieve, from a plurality of sources, data elements of the first data structure, via one or more application programming interfaces (APIs). For example, an API of the one or more APIs includes a REST API or a simple object access protocol API.

In some embodiments, the computing system can harmonize the predicted resource deployment based on one of a continuing resolution, sequestration, or other adjustment to a predicted resource deployment for a current or future temporal period.

In some embodiments, the computing system can generate a graphical depiction of resources deployed corresponding to the descriptors.

Embodiments included herein relate to a non-transitory computer readable medium comprising instructions that, when executed by at least one processor, are configured to cause the at least one processor to perform operations. The instructions can include instructions to obtain a first data structure corresponding to a predicted resource deployment. The instructions can include instructions to present a plurality of predefined functional components based on the predicted resource deployment. The instructions can include instructions to generate executable instructions responsive to a received selection of one or more of the predefined functional components. The instructions can include instructions to present, according to an execution of the executable instructions responsive to the selection of the selected one of the predefined functional components, a plurality of control elements corresponding to a plurality of descriptors. The instructions can include instructions to generate, via the GUI, a second data structure structured according to one or more of the plurality of descriptors.

In some embodiments, the instructions include instructions to compare the predicted resource deployment with a current state of deployed resources to generate harmonization data, wherein the predicted resource deployment comprises a first prediction corresponding to a current temporal period and a second prediction corresponding to a subsequent temporal period.

### BRIEF DESCRIPTION OF THE DRAWINGS

Various objects, aspects, features, and advantages of the disclosure will become more apparent and better understood by referring to the detailed description taken in conjunction with the accompanying drawings, in which reference characters identify corresponding elements throughout. In the drawings, like reference numbers generally indicate identical, functionally similar, and/or structurally similar elements.

FIG. 1 is an example of a data processing system configured to schedule, predict (e.g., forecast), or reconcile resource allocations using a data processing system implemented according to a low code or no-code environment, according to some embodiments.

FIG. 2 is an example of an organizational hierarchy, according to some embodiments.

FIG. 3 is an example instance of a graphical user interface indicating various components of an organizational hierarchy, according to some embodiments.

FIG. 4 depicts some examples of a funding structure table, according to some embodiments.

FIG. 5 is an example instance of a graphical user interface to associate amounts to fund codes, according to some embodiments.

FIG. 6 is an example instance of a graphical user interface to generate reprogramming requests, according to some embodiments.

FIG. 7 is an example instance of a graphical user interface to generate organizational allotment requests, according to some embodiments.

FIG. 8 is an example instance of a graphical user interface to rank various forecasted scenarios, according to some embodiments.

FIG. 9 is an example instance of a graphical user interface to associate a tag with an organizational portfolio, according to some embodiments.

FIG. 10 is an example instance of a graphical user interface to associate a tag with a budget, according to some embodiments.

FIG. 11 is an example instance of a graphical user interface to associate a tag with a line item, according to some embodiments.

FIG. 12 is an example instance of a graphical user interface to generate a tag report, according to some embodiments.

FIGS. 13A-13B depict an example instance of a graphical user interface depicting a tag report, according to some embodiments.

FIG. 14 is another example instance of a graphical user interface depicting a tag report, according to some embodiments.

FIG. 15 is yet another example instance of a graphical user interface depicting a tag report, according to some embodiments.

FIG. 16 is an example flow diagram for a method for the automatic generation of computer-executable code, according to some embodiments.

FIG. 17 is a block diagram illustrating an architecture for a computer system that can be employed to implement elements of the systems and methods described and illustrated herein.

The details of various embodiments of the methods and systems are set forth in the accompanying drawings and the description below.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Conventional technologies for resource allocation and deployment are often hampered by inflexible structures and cyclical review processes that struggle to accommodate the realities of modern organizational demands. These systems typically operate within static frameworks, making it difficult to respond effectively to rapid or unforeseen changes in priorities, such as those triggered by public health emergencies, natural disasters, or shifting geopolitical circumstances. The result is a landscape where organizations face persistent challenges in tracking, reconciling, and adapting resource flows to meet evolving needs. Fragmented reporting, delayed responsiveness, and incomplete visibility into resource utilization are common, especially when emergent categories or priorities were not anticipated during earlier planning stages.

Existing resource management platforms lack the capacity to flexibly tag, aggregate, and reconcile data across hierarchical organizational structures and disparate sources. The absence of mechanisms for dynamic adjustment, supplemental deployment, or sequestration of resources in response to real-time events further exacerbates these limitations. Reporting functions are often siloed, impeding the generation of coherent insights and the harmonization of resource deployment across agencies, departments, or other operational units. Without integrated, descriptor-based frameworks, organizations are unable to capture, present, and reconcile resource flows in a manner that is both granular and adaptable to emergent requirements.

The technology disclosed in this application addresses these shortcomings by introducing a data processing system and computer-implemented methods for descriptor-based presentation and harmonization of predicted resource deployment. The system interfaces with multiple data sources and enables the automatic generation of computer-executable code within low-code or no-code programming software that automatically generates computer-executable code according to user inputs or configurations, which may be entered into the low-code or no-code programming software. Through a configurable graphical user interface, users can select predefined functional components to generate tailored views, modulate reporting functions, and associate tags or descriptors with resource data. These descriptors facilitate dynamic adjustment and supplemental deployment of resources, such that a system or configurations may respond rapidly to changing priorities or other changes.

Embodiments disclosed herein may beneficially implement flexible tagging and aggregation of resource data at various levels of organizational hierarchy, thereby supporting real-time reconciliation and harmonization of predicted and actual resource deployments, and maintains coherency of metrics across multiple organizational levels. By retrieving and harmonizing data from diverse sources via APIs, and by providing user-configurable reporting and visualization tools, the system overcomes the limitations of conventional resource management platforms. Embodiments can include a software programming for adaptably generating executable code or various outputs for descriptor-based presentation and reconciliation of resource deployment data and user interfaces, relative to updates or changes in the resource data or configuration circumstances, such as changes to priorities or allocations.

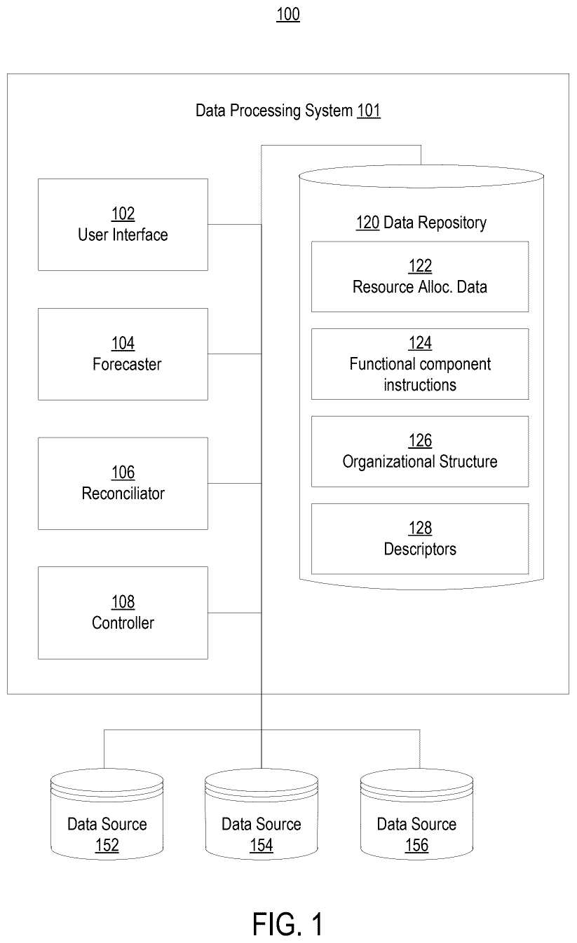

FIG. 1 is an example of a system 100 to schedule, predict, or reconcile resource deployments using a data processing system 101 implemented according to a low code or no-code environment, according to some embodiments. As shown in FIG. 1, the system 100 includes at least one data processing system 101 including components of the present disclosure. The data processing system 101 can include or be instantiated according to operation of at least one computing device, which is sometimes referred to as a computer, without limiting effect. The data processing system 101 can include or interface with various data sources (depicted as a first data source 152, second data source 154, and third data source 156).

The data processing system 101 can include or interface with a user interface 102 to present information to, or receive information from, a display device. For example, the user interface 102 can instantiate various instances to present or receive the information. The data processing system 101 can include or interface with a forecaster 104 to predict a deployment of resources according to various scenarios. The data processing system 101 can include or interface with a reconciliator 106 to reconcile organizational activity to a predicted deployment of resources. Deployment of resources can include allocating of the resources amongst various parties; accordingly, references to deployment of a resources can refer to or include the allocation of those resources.

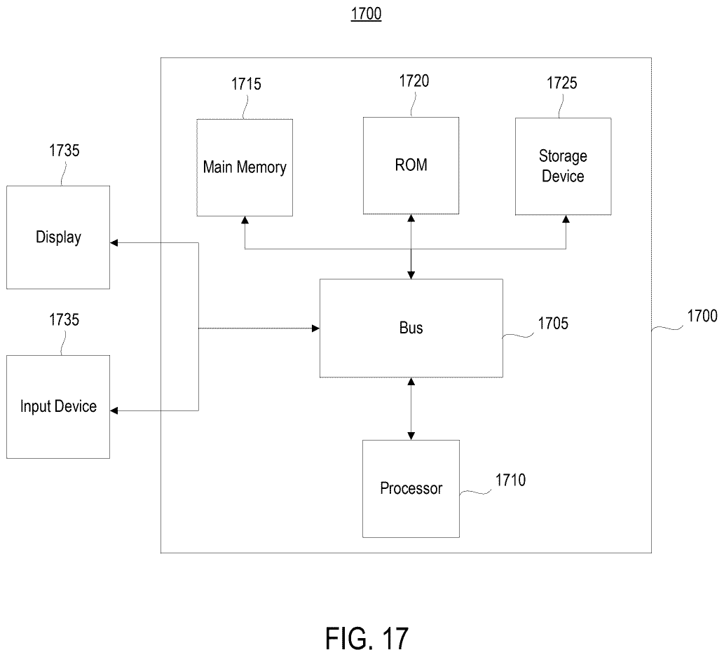

The data processing system 101 can include at least one data repository 120. The user interface 102, forecaster 104, and reconciliator 106 can each include at least one processing unit or other logic device such as programmable logic array engine, or module (e.g., a controller 108) configured to communicate with the data repository 120 or database. The user interface 102, forecaster 104, reconciliator 106, and controller 108 can be separate components, a single component, or part of the data processing system 101. The data processing system 101 and its respective models, engines, and other components can include hardware elements, such as one or more processors, logic devices, or circuits of the controller, as well as software components. For example, the controller 108 of the data processing system 101 can include one or more components or structures of functionality of computing devices depicted in FIG. 17.

The data repository 120 can include one or more local or distributed databases, and can include a database management system (DBMS). The data repository 120 can include computer data storage or memory and can store one or more data structures, such as a data structure corresponding to resource allocation data 122, functional component instructions 124, an organizational structure 126, and descriptors 128 (e.g., metadata tags, database tags).

Resource allocation data 122 may refer to or include any indications of an allocation of resources, such as an organizational budget including various line items as may correspond to various organization activities (e.g., spending, receipts, transfers, or so forth). In some embodiments, a budget or other resource allocation data 122 may include appended descriptors 128, such as tags to indicate relational data between line items or organizations, or to associate further data with the line items. In some embodiments, the resource allocation data 122 can include various instances, as may correspond to potential scenarios. For example, a first instance of resource allocation data 122 can include a “base” scenario, as may correspond to an approved or contemplated budget (e.g., a president's budget). Further scenarios may correspond to any of a sequestration budget, temporary resource allocation or budget (e.g., continuing resolution budget), budget including supplemental or draw-down authority, or a reprogrammed budget (e.g., reprogrammed responsive to contemplated or executed organizational activity such as spending or receipts).

Although resource allocation data 122 may include data stored locally at the data processing system 101, various data items of the resource allocation data 122 may be hosted, maintained, or updated at one or more data sources external to the data processing system 101. For instance, one or more components of the data processing system 101 may be adapted to operate with data items stored in one or more external repositories (e.g., the first data source 152, second data source 154, and third data source 156, as may correspond to data stores of one or more entities or portions thereof). As an example, the various components of the data processing system 101 can execute the operations provided according to the present disclosure based on external data sources 152, 154, 156. In some cases, the various components of the data processing system 101 are configured to interface with the external data sources 152, 154, 156 without modifying the data items thereof. For example, the various components can maintain a local shadow copy with certain updates, or maintain a data structure linking updates with unmodified data items stored in the external data sources 152, 154, 156. For example, a generation of a tag or reprogramming request may be performed and stored locally. If a reprogramming request or other operation is propagated to an external data source 152, 154, 156 (by the data processing system 101 or otherwise), the data processing system 101 may be configured to identify the update, link the update to the locally stored update, and amend the locally implemented change (e.g., to avoid double counting of reprogramming requests, expenditures, or so forth).

Functional component instructions 124 may refer to or include computer-executable instructions configured to generate selectable controls, display elements, input fields, or other aspects of user interface 102 instances. For example, user interface 102 and the controller 108 can generate the functional component instructions 124 responsive to a receipt of a selection of other selectable controls, display elements, input fields, or other aspects of user interface 102 instances. Upon execution, the functional component instructions 124 can modify the operation of various components of the data processing system 101 (e.g., the user interface 102, forecaster 104, or reconciliator 106). In some cases, the data processing system 101 can be implemented according to a low code or no-code environment, such that functional component instructions 124 generated according to information received by the user interface 102 can modify a presentation, computation, or other operation involving the resource allocation data 122. For example, a change to an approval routing may be implemented responsive to a change in organizational structure via the user interface, though some such operations may be managed by a role-based access schema to prevent unauthorized actions.

An organizational structure 126 may refer to or include a data structure indicative of a relationship between various constituent components of an organization. For example, in the public sector context, an organizational structure 126 may correspond to the federal government, such as the various multi-agency departments, agencies, regions, offices, teams, or other entities. In some embodiments, the organizational structure 126 can include a hierarchical structure, such as a structure including various regional offices or departments constituent to a national office, or various teams constituent to a regional offices. In some embodiments, the organizational structure 126 includes non-hierarchical components. For example, a task force drawing on cross-agency expertise can include a first office, team, or other structure of one agency and a second office, team, or other organizational structure of another agency, absent a hierarchical relationship therebetween. In some embodiments, the data processing system can generate a “placeholder” for the task force, even where the task force may operate informally or otherwise not be included within resource allocation data 122.

In some embodiments, a granularity of the resource allocation data 122 corresponds to a matching granularity of the organizational structure 126. For example, a budget can allocate line items of a budget to at least one portion within at least one hierarchical level of the organizational structure 126. In some embodiments, a granularity of the resource allocation data 122 differs from the granularity of the organizational structures 126. In some cases, a budget can allocate line items at an agency level, where agency activity can occur at various organization levels. As an example, a budget can allocate funds to capitol expenses in a Midwest region, where organizational activity includes renovations to a Chicago office, Minneapolis office, and so forth.

Descriptors 128 may refer to or include a tag or other metadata-based association appended to or otherwise associated with a line item or organizational activity (e.g., spending, receipt, or reprogramming). For example, the tag can indicate a data item is associated with an event, initiative, or other relevant category. In some embodiments, the event, initiative, or other category may be emergent or otherwise omitted from one or more instances (e.g., scenarios) of an as-received budget or another resource allocation data 122 instance. In some embodiments, a portion of the descriptors 128 can correspond to line items or other aspects of received resource allocation data 122. For example, a descriptor 128 can identify spending or other organization activity within a region, department, regarding citizens or non-citizens, or so forth. Inclusion of such descriptors 128 upon receipt of the resource allocation data 122 can, like generation of the descriptor 128 thereafter, aid in the generation of metrics, approvals, or reporting functions. For example, allocations associated with an emergent condition such as the COVID-19 pandemic, disaster relief, or unplanned military operations can be tracked using such tags, even where the spending may not have been previously associated with any planned spending. Embodiments of the present disclosure can include descriptors 128 adaptable for presentation or selection by user interface 102 instances to generate computer executable code to generate or display reporting on organizational activity, as may update according to various data sources (e.g., data source 152, data source 154, and data source 156). In some cases, the data sources 152, 154, 156 may include streaming updated during operation of the data processing system 101.

Upon generation of a descriptor 128, the descriptors 128 may be presented to further users, as may avoid the generation of duplicative instances of a descriptor 128 (e.g., “COVID19,” “COVID-19,” “public health emergency (PHE),” or so forth). For example, a descriptor 128 generated according to generation of computer executable code according to an actuation of control elements of one instance of the user interface 102 may cause the presentation of the descriptor 128 via further instances of the user interface. Further, like other aspects of the user interface 102 instances, the presentation or generation of descriptors 128 may be restricted according to a user access level or role.

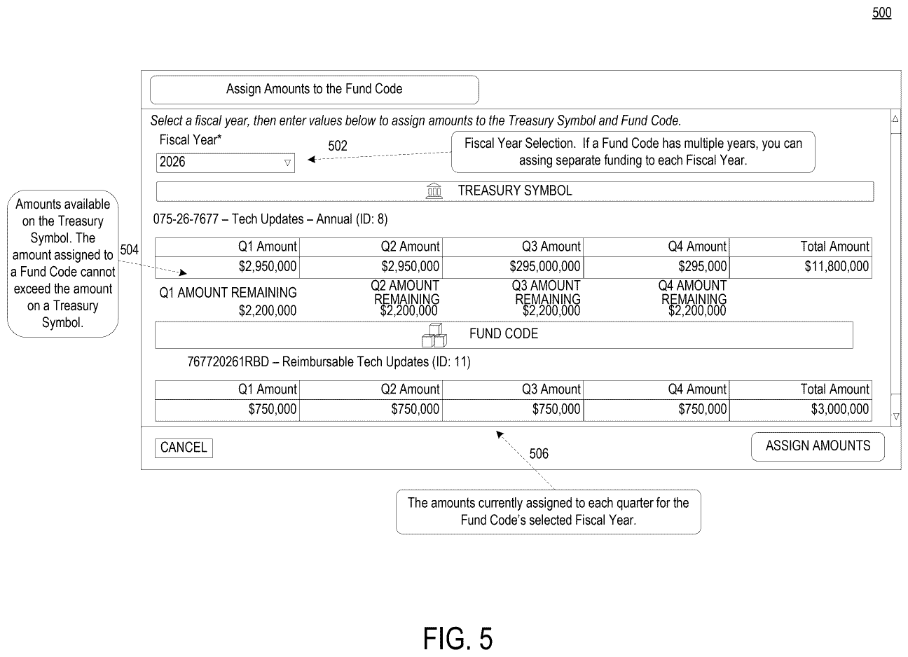

The user interface 102 can include or interface with various input or output devices to exchange (e.g., obtain or provide) information with a user. For example, the user interface 102 can include or interface with a display device to exchange the information. The display device can include a visual, audio-visual, or audio device, and can receive information via a touchscreen, mouse, keyboard, stylus, or applications programming interface (API). The API can include, for example, a representational state transfer (REST) API or a simple object access protocol (SOAP) API. The user interface 102 can further exchange information with various of the other components of the data processing system 101. Some examples of user interface 102 instances are provided henceforth, such as at each of FIGS. 5-15. Such illustrative examples are not intended to limit the present disclosure.

The user interface 102 can implement user access controls for various views (e.g., instances) upon a receipt of data or execution of predefined functional component instructions 124. For example, the user interface 102 can receive an indication (e.g., username, password, or other token) of a user identity of a user and restrict, based on a classification of the identity, a presentation of control elements configured to present or receive information. Further, the user interface 102 can restrict the generation of computer executable instructions according to the classification of the user identity, to prevent the generation of additional flows from unauthorized users. The user interface 102 can provide control elements to receive non-predefined instructions for execution from one or more user classes. Such control can provide flexibility, but may expose large data sets and control of an operation of the data processing system 101 to such a class of users. Accordingly, such a class, if supported, may be limited to administrative, technical, or other approved identities.

In some embodiments, the user interface 102 presents one or more predefined functional component instructions 124 to all or a subset of users. For example, the predefined functional component instructions 124 can include objects configured to generate computer executable instructions to modify further aspects of the user interface 102. The predefined functional component instructions 124 may reduce a quantity of operations or training functions to implement such changes (e.g., using a no-code environment). Further, the predefined functional component instructions 124 can be configured to avoid certain data changes, or restricted activities, according to a user-based access control scheme.

In some embodiments, the user interface 102 is adapted to omit a selectability of the predefined functional component instructions 124 for one or more classes of users. For example, such an implementation can avoid propagation of duplicate or generation of an unwieldy number of tags or other descriptors 128. In some embodiments, at least a portion of tags may be generated as limited to an amount of users, or organizational portions. In this way, tags may be generated to distinguish activities of regional offices or teams, without presentation to peripheral organizations. For example, a tag implemented by a regional office to distinguish between operational support and development activities for a local project need not be presented to those in other organizations or other regions. In some embodiments, a user lacking access for predefined functional component instructions 124 or other aspect of the user interface 102 can execute at least a subset of restricted operations in a staging or shadow environment, as may be routed to and implemented according to an authorized approver.

The forecaster 104 can predict an allocation of resources according to various scenarios. The forecaster 104 can receive resource allocation data 122 from the various instances of the user interface 102, and predict updated resource allocation data based thereon. For example, in the context of budgets, the forecaster 104 can predict a change to a budget based on a sequestration scenario, a supplementation of resources (e.g., supplemental appropriation), reprogramming requests, or so forth.

The forecaster 104 can predict an allocation of resources based on descriptors 128 (e.g., tags). Such a prediction is sometimes referred to as a forecast, without limiting effect. The forecaster 104 can forecast resources allocated as associated with (or not associated with) one or more descriptors 128 assigned subsequent to a receipt, by the data processing system 101, of the resource allocation data 122. For example, the data processing system 101 can receive the resource allocation data 122 prior to a generation or association of a descriptor 128 with such resource allocation data 122. The forecaster 104 can receive, via the user interface 102, instructions to associate a descriptor 128 with at least a portion (e.g., a line item) of the resource allocation data 122. The forecaster 104 can forecast, responsive to the association, organizational activity associated with one or more descriptors 128. Such organizational activity can include, for example, spending, receipts, hiring, or contracting.

The forecaster 104 can forecast according to various time periods. For example, the forecaster 104 can forecast according to a current period (e.g., a current fiscal year or quarter) or an out period (referring to a period which has not yet begun). In some embodiments, the forecaster 104 can forecast according to a prior year, such as where complete information may not be available, or where predictions for other than reconciled data are requested.

The reconciliator 106 can reconcile organizational activity with resource allocation data 122 such as a forecasted allocation of resources. For example, the reconciliator can compare a forecasted resource allocation with a current state resource allocation to generate reconciliation data. The reconciliation data, in turn, can indicate a zero or non-zero difference between various data elements and sets thereof. In the context of budgets, the reconciliator 106 can reconcile various organization activities such as spending, receipts, or reprogramming with resource allocation data 122. In a more general context, the reconciliator 106 can harmonize those or further organization activities with resource allocation data 122. For this reason, the alignment of the organizational activity with resource allocation data 122 is sometimes referred to as harmonization. Such harmonization should be construed to include at least the reconciliation examples provided according to the present disclosure.

The reconciliation can refer to or include reconciliation to a current year, an out year, or a prior year. In some instances, the reconciliation can refer to generating a future (or current) year projection based on a planned, president's or other tentative budget. For example, an organization can anticipate a maintenance, increase, or reduction of funding. Upon a completion of a budget, as may vary from the forecast, the reconciliator 106 can determine a difference between the forecasted and received budget and determine an overage, underage, or other imbalance of the budget (e.g., a received budget may exceed a forecasted budget for some line items and fall below the budget for others).

The reconciliator 106 can associate descriptors 128 (e.g., tags) with various data items of the present disclosure. For example, upon receipt, via the user interface 102, of organizational activity or line times with the descriptor, the reconciliator 106 can update the resource allocation data 122 or otherwise maintain a linkage (e.g., via a lookup table) between the descriptors 128 and the various aspects of the resource allocation data 122. Reconciliation can include a comparison of organizational activities (e.g., spending or receipts) within a planned period to organizational activities outside of such a period. For example, if a program incurs delays or pull-forwards, the reconciliator 106 can maintain traceability between a forecasted activity of a previous or subsequent period with a period of the organizational activity.

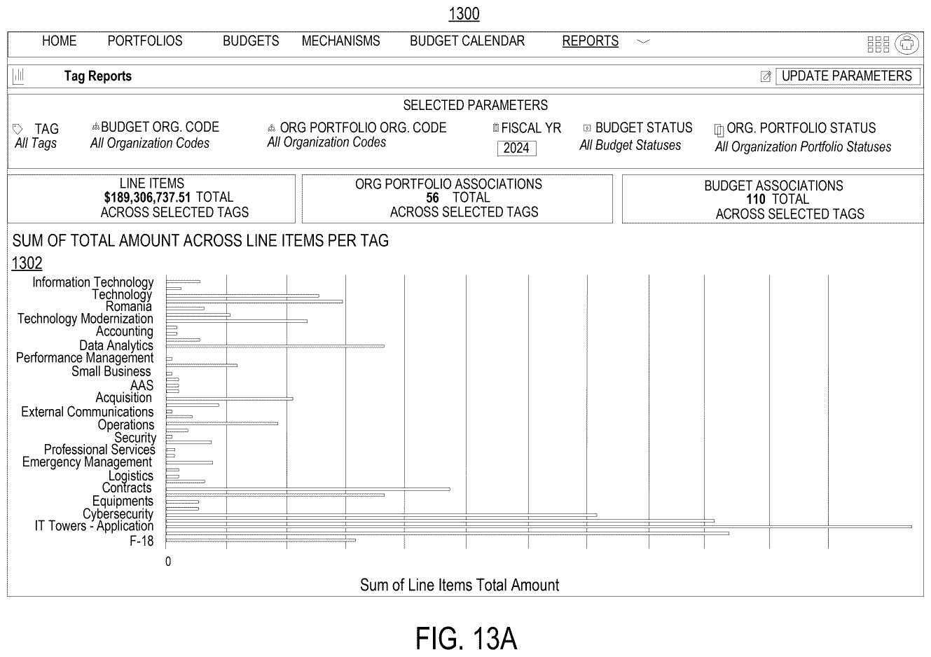

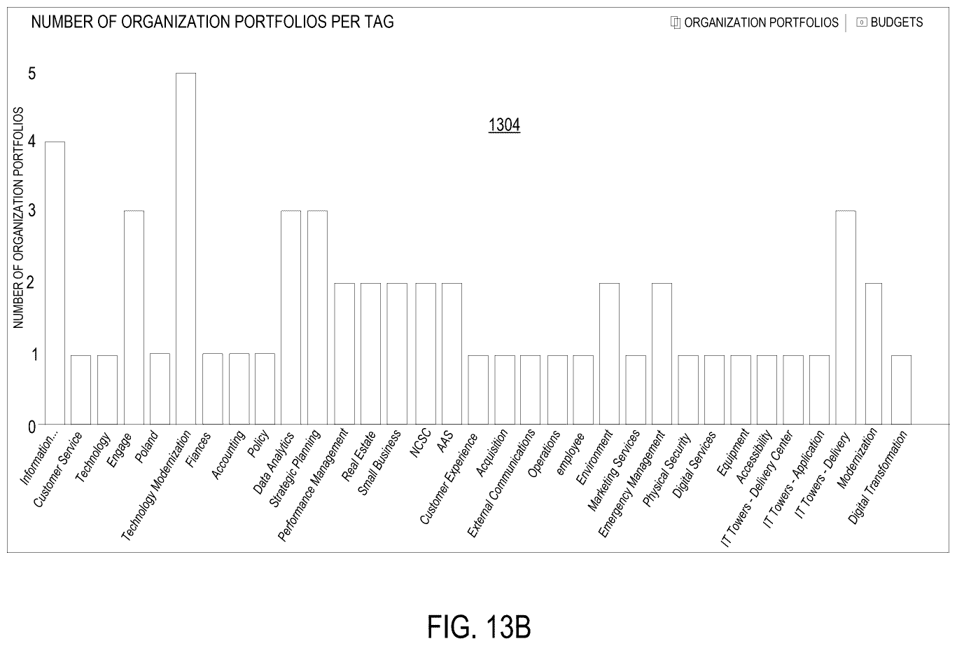

The reconciliator 106 can reconcile organizational activity with the resource allocation data or the descriptors 128. For example, the reconciliator 106 can generate reconciliation reports to indicate various organizational activity associated with tags. Some examples of such reporting are provided hereinafter with regard to, for example, FIGS. 13A-15.

The reconciliator 106 can map traceability between various organizational levels. For example, the reconciliator 106 can generate a data map that correlates data elements corresponding to organizational activities at various hierarchical levels. The data map enables the reconciliator 106 (or other component of the system 100) to maintain coherency between organizational activities and goals or directives. For example, an agency level goal can include increasing engagement with underrepresented communities. Additional locally executed components may support certain goal, such as printing costs of brochures for a meeting, venue rentals, or so forth. The reconciliator 106 can trace, according to an inclusion of a descriptor 128, such activities to the agency goal. In this way, the reconciliator 106 can determine an alignment of organizational goals with organizational activities. Accordingly, such a map may be referred to as maintaining coherency (e.g., of metrics, goals, or so forth) between the various organizational levels.

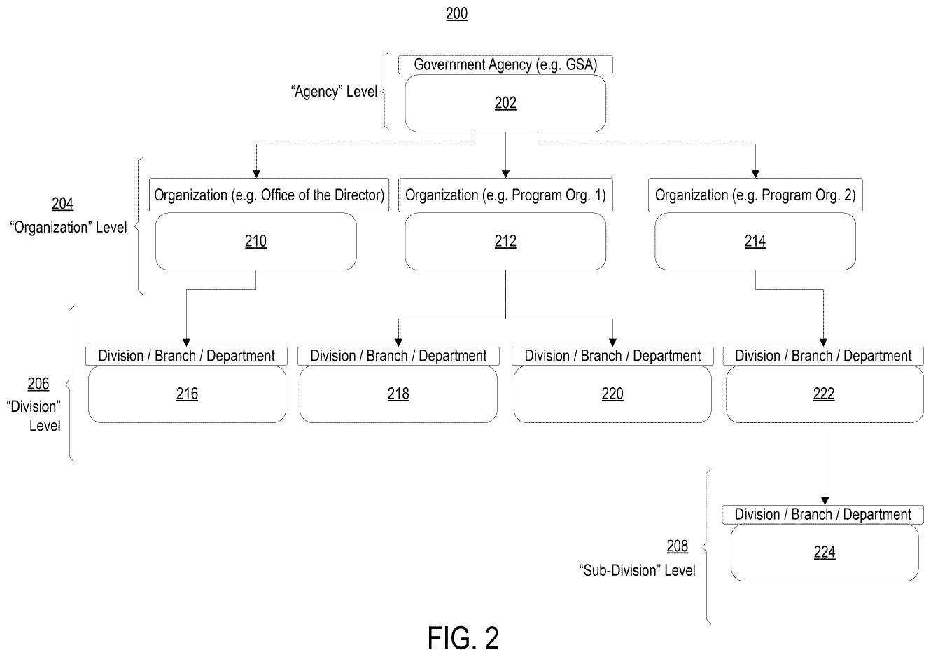

FIG. 2 is an example of an organizational hierarchy 200, according to some embodiments. The organizational hierarchy 200 includes a top-level organization, such as according to the illustrative example of an agency 202 (e.g., the centers for disease control, CDC, department of defense, DOD, or so forth). According to some embodiments of the present disclosure, a top-level organization can be other than an agency (e.g., can be a portion of an agency or a multi-agency department). An agency 202 or other top-level organization can include one or more constituent organizations 204. For example, continuing the example of the CDC above, the agency 202 can include an Office of the Director constituent organization 204, Center for Injury Prevention constituent organization 204, or Center for Immunization constituent organization 204. Each of the constituent organization 204 further include or be subdivided into various divisions, branches, departments, or other organizational structures 206. Such structures can further include or be subdivided into various further organizational structures 208.

Resource allocations (e.g., budgets) can relate to organizations according to various levels thereof. For example, a budget can specify various line items as associated with various portions of the organizational hierarchy 200, or spending can be reconciled according to activity of various of the levels of the organization hierarchy 200. For example, the descriptors 128, resource allocation data 122, or other operations of the present disclosure may be executed at one or more organizational levels, including between organizational levels. Accordingly, the lower levels may be aggregated at progressively higher levels of the hierarchical structure. For example, the AAA portion 216 can be aggregated into the AA portion 210. In turn, the AA portion 210, AB portion 212, and AC portion 214 can be aggregated into A, at the level of the agency 202.

In some instances, the organizational structure 126 includes a unique identifier for various constituent portions. For example, an agency 202 level identifier can be provided as “A.” Constituent portions can inherit the A and append a further identifier. For example, second level constituent portions can include a AA portion 210, AB portion 212, or AC portion 214 designator. Each of the constituent portions can include one or more third level (and so on) further constituent portions as may inherit a designator and append a further identifier. For example, the AA portion 210 can include a constituent AAA portion 216. The AB portion 212 can include a constituent AAA portion 216. The AC portion 214 can include a constituent AAB portion 220 and AAC portion 222 (which may itself include a AAB1 constituent portion 224, and may further include a AAB2, AAB3, and so on). Such designators of the organizational structure 126 are sometimes referred to as an organizational code identifier, as may refer to the constituent portion, and preserve inter-entity relationships (e.g., according to an inherited portion of the organizational code identifier).

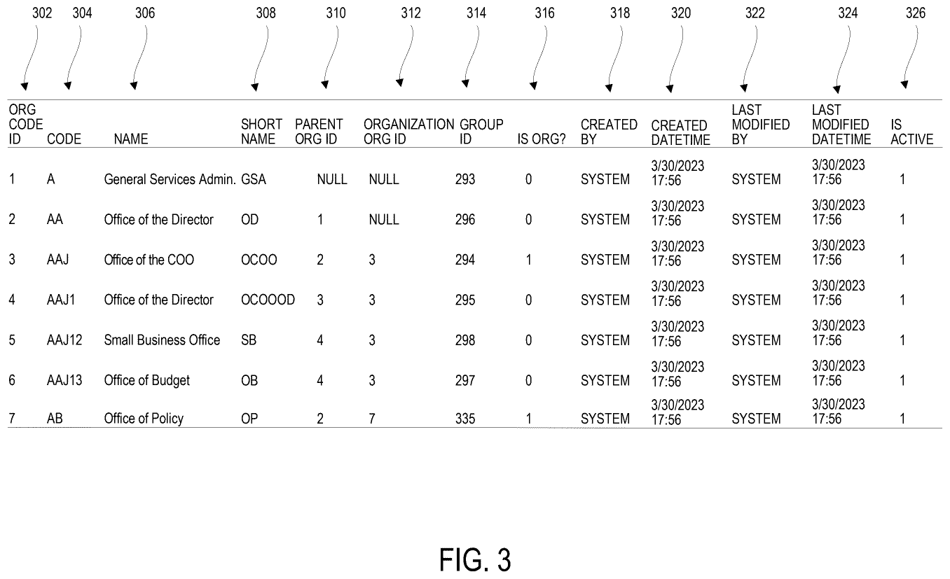

FIG. 3 is an example instance of a graphical user interface 300 (GUI) indicating various components of an organizational hierarchy, according to some embodiments. For example, the depicted table may include various data structures to correspond to various entities of the organizational structure 126.

A first column 302 depicts a data item of a primary key as may be used to reference, organize, store, retrieve, or otherwise interface with data elements of the row, on a per-entity basis. A second column 304 depicts a further data item of the organizational code referred to above. A third column 306 depicts a further data item of a descriptive name of the organization, as may be presented according to various instances of the user interface 102. A fourth column 308 depicts a further data item of an abbreviated instances of the descriptive name. Such a data item may be used in certain views to reduce a size of displayed content. A fifth column 310 depicts a further data item of a parent code identifier, indicating a parent organization (e.g., the organization from which a portion of the organizational code identifier is inherited). For example, the data item of the fifth column 310 can correspond to a data item of the first column 302 of the parent organization.

A sixth column 312 depicts a further data item of a related organization (e.g., one step down from the agency 202 level). As is depicted, some rows may lack such a data item, corresponding to an organization which is at the agency level or otherwise not constituent to the agency level. Other rows may include a self-referential data item in the sixth column 312, indicating that the level is a formal organization, referring to an organization recognized by the functional component instructions 124 or user access controls. That is, the organization can correspond to an organizational structure of an application to generate code (e.g., the low-code/no-code environment). A seventh column 314 depicts a further data item of the low-code/no-code environment. For example, each row can correspond to a separate group. Taking the AAB1 org code group as an example, the direct members of this group will be (i) individual users added to at the AAB1 level and (2) the AAB organization code group. Even though AAB is the parent of AAB1, the AAB org code group is a parent of the AAB1 org code group. This aids users in the AAB org code group to take any actions that are limited to only members of the AAB1 org code group, because everyone in the AAB group can be further assigned (e.g., automatically assigned) to the AAB1 group. An eighth column 316 depicts a further data item indicating that the organization is a formal organization. A formal organization may be configured to have viewers or other access controls at such a level.

A ninth column 318 depicts a further data item indicating a source of creation of the group (e.g., system created or manually created). A tenth column 320 depicts a further data item of the creation time of the group (referring to the system creation time, such as may correspond to a receipt of the resource allocation data 122). An eleventh column 322 depicts a further data item indicating a last modification for an organization of the row, while a twelfth column 324 depicts a corresponding data item of a time for the modification. A thirteenth column 326 depicts a further data item indicating whether the row corresponds to an active or inactive organization.

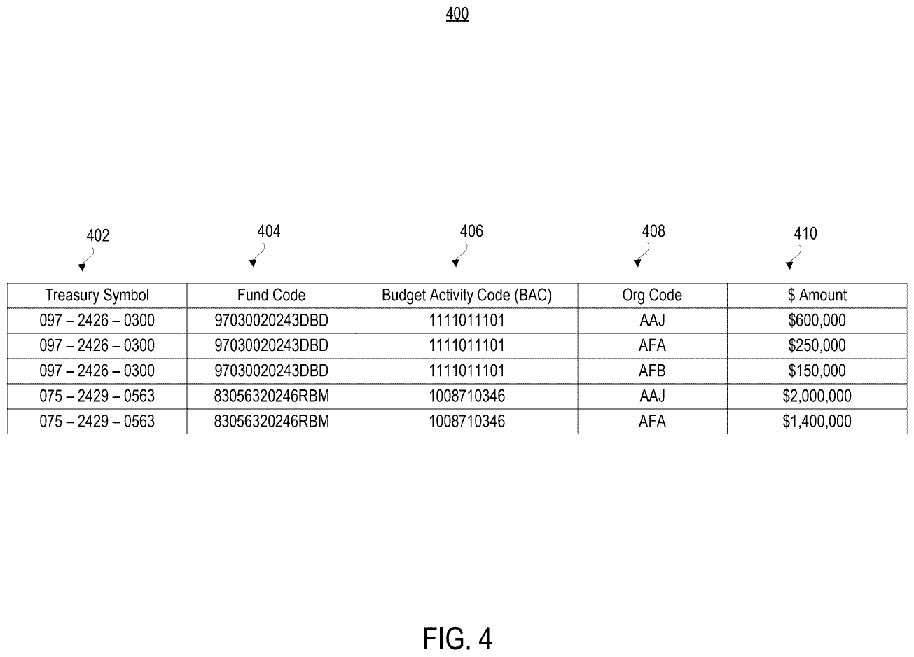

FIG. 4 depicts some examples of a funding structure table 400, according to some embodiments. For example, the depicted table 400 may correspond to various data structures of the resource allocation data 122.

A treasury symbol column 402 can include a concatenation of various data items such as an agency identifier, period of availability (e.g., 2426 can refer to availability between fiscal year 2024 and 2026), and account number. The account number can correspond to one or more tables of the budget (e.g., the resource allocation data 122). A fund code column 404 can include identifiers including the account number (e.g., equal to or otherwise derived from the account number of the treasury symbol, such as the “0995” or “0563” of the illustrative example). The fund code column 404 can further include an appropriation year or period of availability. Further elements of the fund code can depict discretionary or mandatory spending, category A or B spending (referring to more essential or more flexible items, respectively), or direct or reimbursable spending. A budget activity column 406 depicts budget activity codes (BACs). BACs are persistent across years, and identify more particular organizational activity. The resource allocation data 122 can link one or more BAC to each program, project, or activity (PPA, not depicted). BACs need not be divisible between multiple PPA.

An organization column 408 indicates an identifier for an organization (depicted as the organizational code identifier). An amount of an amount column 410 indicates a quantity of allocated resources (depicted as dollars according to the present illustrative example).

FIG. 5 is an example instance of a GUI 500 (e.g., graphical user interface 102) to associate amounts with fund codes, according to some embodiments. The depicted instance of the GUI 500 can be instantiated responsive to a user actuation of a control element of the GUI 500 subsequent to the generation of one or more fund codes corresponding to at least one treasury symbol. A first control element 502 is configured to receive a period (e.g., fiscal year) selection corresponding to the availability of the fund code. A set of second control elements 504 are configured to receive an indication of amounts of an allocated resource for various periods (depicted as quarters of the fiscal year). A set of third control elements 506 can be configured to indicate a reimbursable amount of the amounts entered in the second control elements 504. Any of the elements of the present instance of the GUI 500, or any of those provided henceforth, can be generated or further modified according to the low-code/no-code environment described herein.

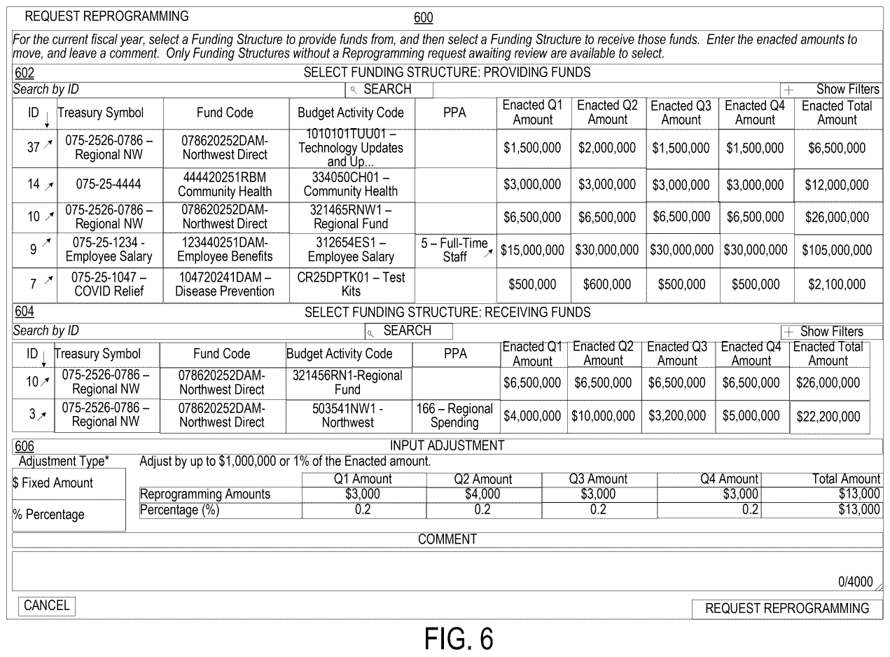

FIG. 6 is an example instance of a GUI 600 (e.g., graphical user interface 102) to generate reprogramming requests, according to some embodiments. Reprogramming requests may refer to or include a relocation of resources without a change to a treasury symbol. The depicted instance of the GUI 600 can be instantiated responsive to a user actuation of a control element to adjust amounts between or within various organizational codes, line items, or so forth. A first frame 602 depicts a set of identifiers corresponding to a receipt of resources for the reprogramming requests (e.g., a source for funds). A second frame 604 depicts a set of identifiers corresponding to a provision of resources for the reprogramming requests (e.g., a sink for the funds). A third frame 606 of the GUI 600 includes a selection of an amount for the programming request, such as a percentage or absolute quantity. The GUI 600 may be configured to receive a comment or other documentation corresponding to the request. In some cases, (e.g., according to an access control level or role), the instance of the GUI 600 may include for presentation or otherwise implement a reprogramming request limit (e.g., one percent). Upon approval (e.g., by a same or different user according to an access control level or role), the user interface 102 can provide the received information to another component of the data processing system 101 to update the resource allocation data 122.

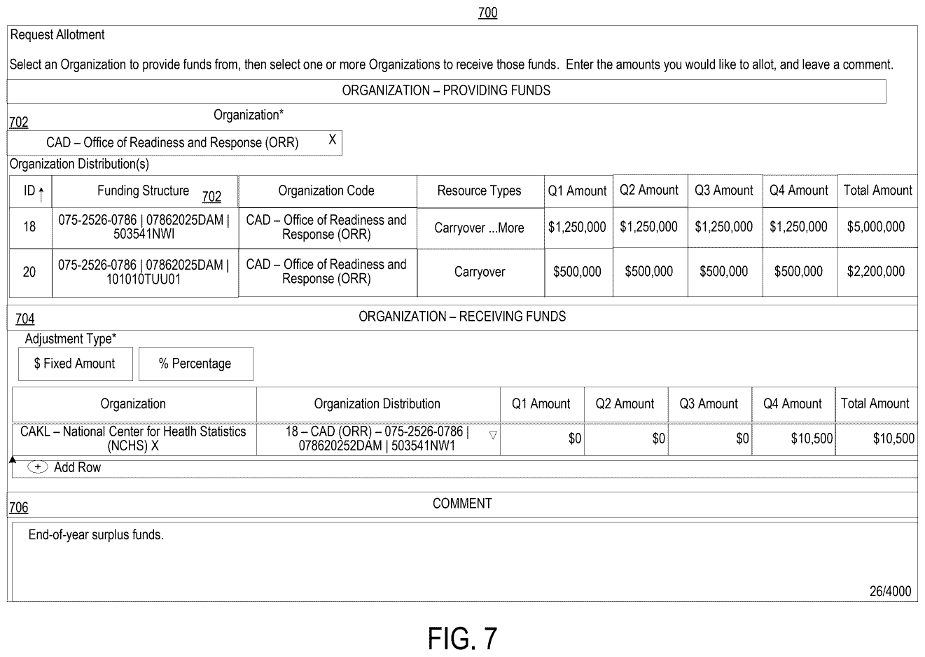

FIG. 7 is an example instance of a GUI 700 (e.g., graphical user interface 102) to generate organizational allotment requests, according to some embodiments. Organizational allotment requests may refer to or include allocations of funds between organizations within a same funding structure within a same fiscal year. A first frame 702 depicts a set of identifiers corresponding to a receipt of resources for the reprogramming requests (e.g., a source for funds). A second frame 704 depicts a set of identifiers corresponding to a provision of resources for the reprogramming requests (e.g., a sink for the funds), as well as an organization distribution of the receiving entity (to identify the funding structure). Where a receiving organization is not already associated with an organization distribution, the entry of the allotment request can cause the data processing system 101 to generate such an organization distribution. A comment field 706 can receive data, as may be routed for approval in some cases.

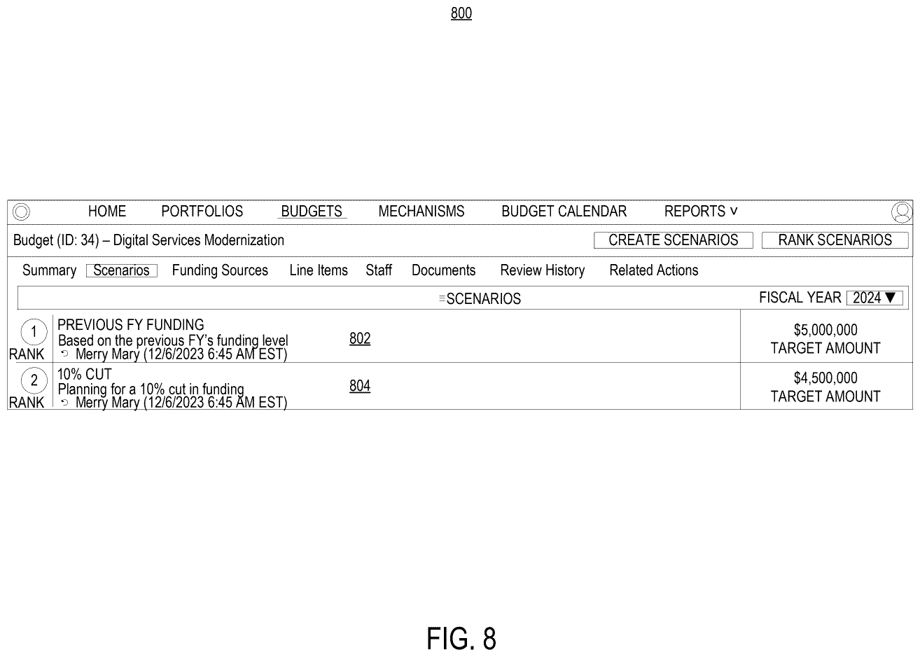

FIG. 8 is an example instance of a GUI 800 (e.g., graphical user interface 102) that depicts a rankings of various forecasted scenarios, according to some embodiments. The various scenarios can intermediate line items of resource allocation data 122 from the resource allocation data 122 itself. For example, resource allocation data 122 (e.g., a budget record) can include a one-to-n relationship with scenario records. In turn, each scenario record can include a one-to-n relationship with a line item. Accordingly, a selection of a scenario can select its constituent line items for the budget record. According to the depicted view, a first scenario 802 continues resource allocation levels from a previous year, while a second scenario 804 corresponds to a ten percent reduction of the allocation levels. Each scenario can include various organizational activities, such as staffing levels, spending, or other aspects associated with the various line items.

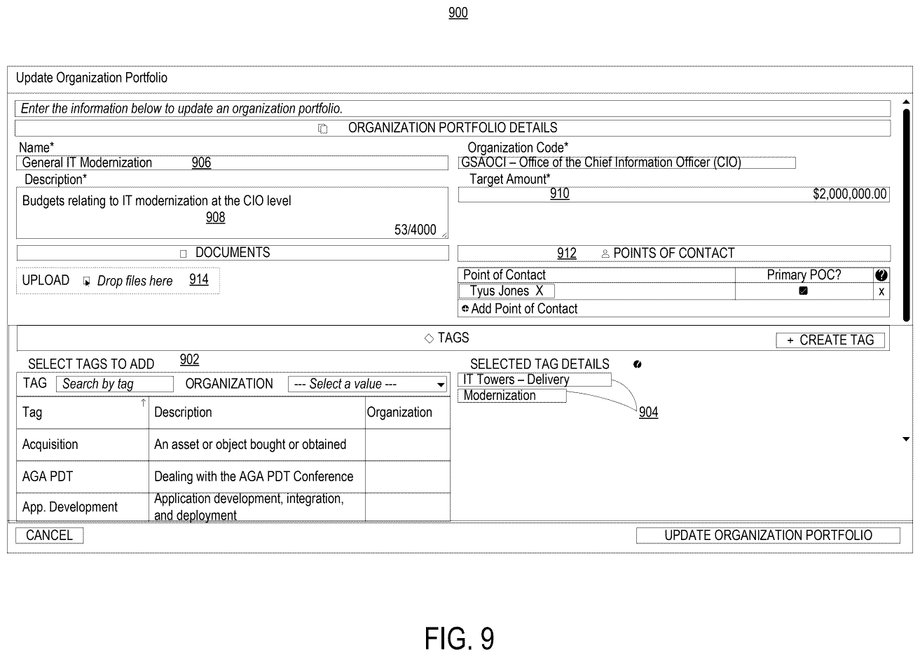

FIG. 9 is an example instance of a GUI 900 (e.g., graphical user interface 102) to associate a tag with an organizational portfolio, according to some embodiments. The tags referred to herein may refer to tags generated subsequent to an initial provision of resource allocation data 122, tags provided along with the resource allocation data 122, or other descriptors of the present disclosure. In some embodiments, the tags may be substituted for other descriptors 128. The presently depicted instance of the GUI 900 is provided with various illustrative examples of included fields. Like other of the illustrative instances provided herein, the fields should not be construed as limiting. Some instances of the user interface 102 of the present disclosure will omit, substitute, add, or otherwise modify the fields provided herein. For example, some fields may be omitted/added entirely, modified, or exchanged between various of the user example instances provided herein. Such adjustments may be for all users, or according to an access control system such as a role-based system.

The depicted instance (or view) of the GUI 900 includes one or more control elements 902 configured to select tags (or other descriptors 128 [symbol] , and an indication of any presently selected tags 904 (or other descriptors 128 [symbol] . That is, in some embodiments, multiple tags may be associated with an organization portfolio, as may aid in reporting of organizational activity associated with multiple tags. For example, according to the example GUI 900, an organizational portfolio of general IT modernization is associated with each of an “IT towers”, and “Modernization” tag. The GUI 900 includes an entry field 906 for the organizational portfolio and an associated description entry field 908. Further provided are target resource allocation quantities 910 for the organization portfolio, one or more points of contact 912 for the organizational portfolio, or other reference information for the organizational portfolio, as may include sponsors, associated addresses, goals or mission statements for hierarchical traceability, or so forth. In some embodiments, the reference information can include free text fields, upload fields 914, or linkages with other data structures or instances of one or more user interfaces 102 of the present disclosure.

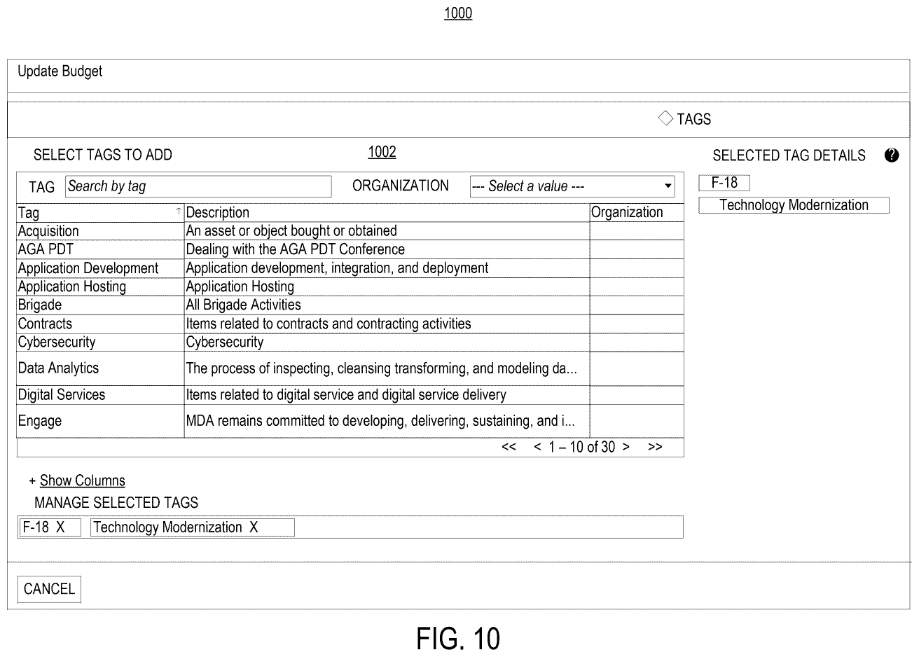

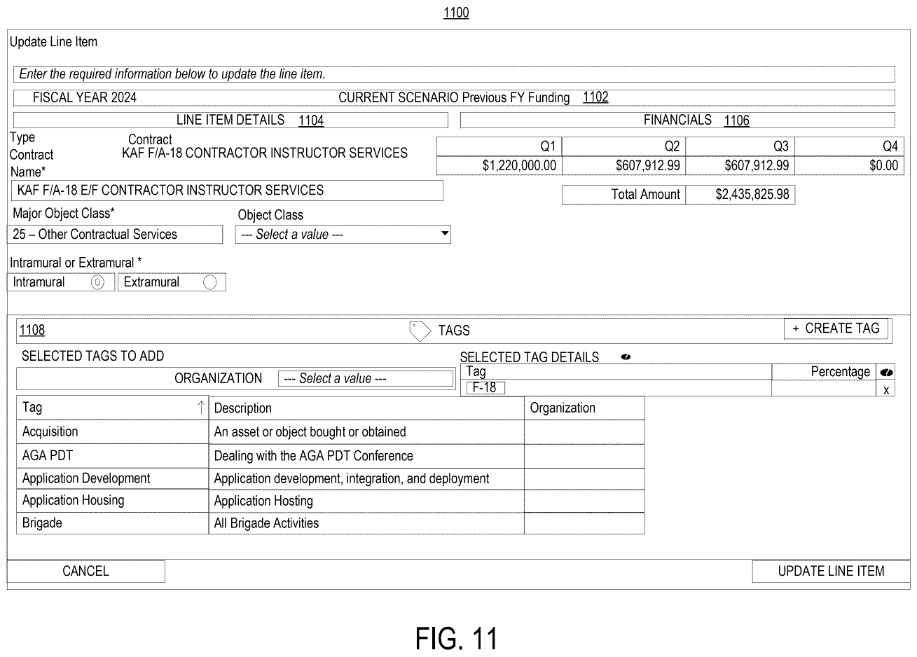

FIG. 10 is an example instance of a GUI 1000 (e.g., graphical user interface 102) to associate a descriptor 128 (e.g., a tag) with a budget or other allocation of resources, according to some embodiments. For example, as indicated one or more control elements 1002 configured to select tags are provided. The control elements 1002 may be generated according to shared predefined functional component instructions 124 as the control elements 902 of the GUI 900 of FIG. 9 (e.g., according to a same module of a no-code/low-code environment). As is indicated, one or more tags may be provided to indicate an association with a particular program of record. In this way, a budget can be associated with a subset of tags, as may ease their selection for individual line items or scenarios. For example, the GUI 1000 can be provided to a first subset of users, and such tags may be selected via the GUI 1100 depicted at FIG. 11, henceforth. Moreover, the various displays may be presented or selectable according to a role-based authentication based on user identity, as for any of the instances or fields thereof according to the present disclosure. The generation of descriptors 128, and their association with various line items or subsets thereof can, according to the present disclosure, maintain an association with categories. Such association may be useful with regard to mid-year reporting or planning for emergent or other categories as may not have been included in the original allocation FIG. 11 is an example instance of a GUI 1100 (e.g., graphical user interface 102) to associate a descriptor 128 (e.g., a tag) with a line item, according to some embodiments. For example, the depicted embodiment can correspond to a single line item for a single scenario (depicted as a continuation of “previous FY funding” 1102). In some embodiments, further control elements (or separate instances of the GUI 1100) are provided to adjust an association with a tag according to various scenarios. Line item details 1104 can include various selectable control elements, display fields, or entry fields. Some illustrative examples of such fields include a type, name, object class(es) or subclass(es), and indication of intramural or extramural activity. Intramural activities may refer to or include activities internal to an agency 202 or other organization. Extramural activities may refer to or include activities outside the agency 202, such as via universities, private organizations, research institutions, or other non-governmental entities.

Resource allocation details 1106 can provide further information as to allocated resources, such as temporal, organizational, or other subdivisions thereof. Control elements 1108 configured to select the tags are provided. Such control elements 1108 may inherit (or deviate from) properties or functionality, relative to corresponding control elements 902, 1002 as depicted according to FIG. 9 and FIG. 10 of the present disclosure.

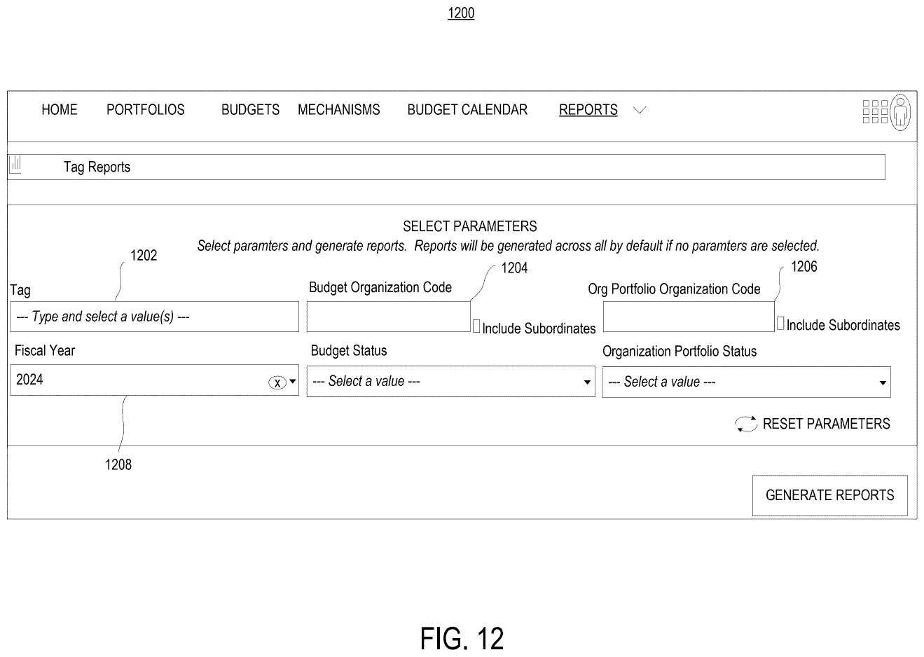

FIG. 12 is an example instance of a GUI 1200 (e.g., graphical user interface 102) to generate a report as associated with a tag or other descriptor 128, according to some embodiments. The GUI 1200 is configured to receive an indication of at least one descriptor 128 (e.g., via a first selectable control element 1202 or other of the corresponding control fields provided herein), and one or more indications of an organization. For example, the organizational indication may be provided as a budget organization code (via a second selectable control element 1204, depicted as a text entry field), portfolio organization code (via a third selectable control element 1206, also depicted as a text entry field). A further selection of one or more periods may be selected, according to a fourth selectable control element 1208. Further selections can include a budget or organizational status, scenario, or so forth.

FIGS. 13A and 13B depict an example GUI 1300 (e.g., graphical user interface 102) depicting a report as associated with a tag or other descriptor 128, according to some embodiments. The depicted GUI 1300 provides a view for multiple tags (e.g., according to a non-selection of any of the control elements of the GUI 1200 of FIG. 12). A first display element 1302 provides a resource allocation amount corresponding to each of those various tags. A second display element 1304 is provided on FIG. 13B, and provides a quantity of organizational portfolios corresponding to each of the tags. According to such views, a user may receive data indicative of pareto drivers of a particular tag, or of resources more generally, across various entities and descriptors 128. In some embodiments, the second display element 1304 can be provided on a same GUI 1300 as depicted in FIG. 13A. Indeed, various elements of the various user interface instance provided herein can be provided on a same or separate instances of the GUI 1300.

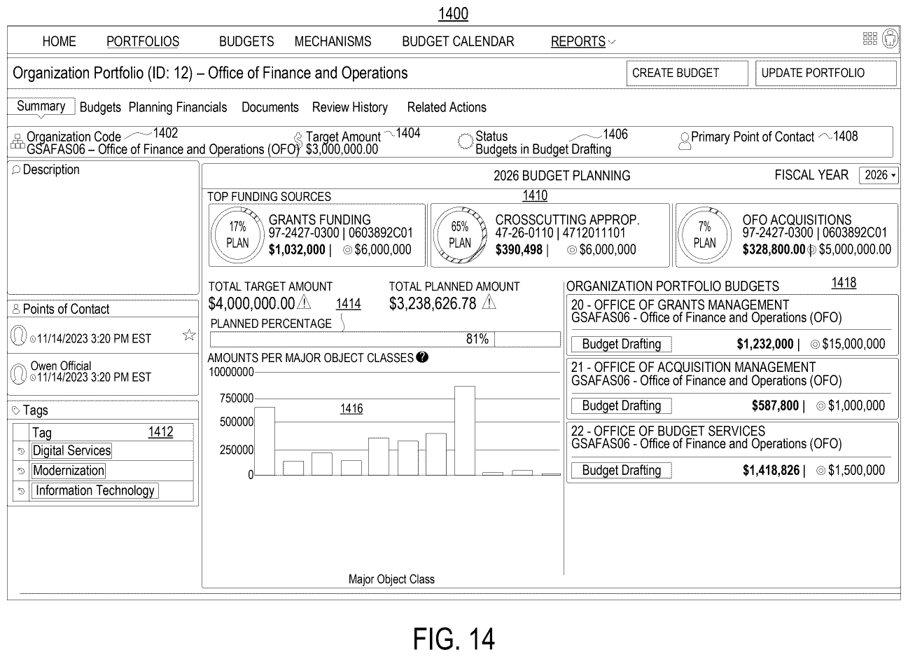

FIG. 14 is another example instance of a GUI 1400 (e.g., graphical user interface 102) depicting a report as associated with a tag or other descriptor 128, according to some embodiments. The provided view may be presented as a dashboard corresponding to a particular organizational portfolio. In some embodiments, the various views of the present disclosure may be selected according to a user selection of a corresponding control element. In some embodiments, the various views of the present disclosure may be automatically selected according to a quantity of line items, organizational portfolios, tags, or so forth, returned according to a search.

The present view includes a first indication 1402 of an organizational portfolio relative to an organizational structure 126. In some embodiments, the first indication 1402 is selectable to cause the user interface to present further organizational structure 126 information. A second indication 1404 provides a target resource allocation for one or more scenarios. A third indication 1406 provides an indication of a status (e.g., drafting, complete, authorized, pending, reconciled, or so forth). In some embodiments, the user interface 102 is configured to provide distinct views according to various of the statuses. Various reference information such as a point of contact 1408, may be indicated via the present view. Such elements may be selectable to retrieve further information such as a reviewer/approver, contact information, routing information, and so forth.

Further depicted are indications of funding sources 1410 and one or more tags 1412 associated with the organizational portfolio. In some embodiments, all descriptors 128 associated with the organizational portfolio are presented. In some embodiments, the user interface 102 is configured to evaluate all descriptors 128 associated with the organizational portfolio to select a subset of the descriptors 128 for presentation. For example, the underlying server operations of the GUI 1400 can rank-sort the descriptors 128 according to a number of line items, amount or allocated resources, or another metric and select a subset of the descriptors 128 according to a view (e.g., a predefined number or a number corresponding to a presented prominence). In some embodiments, the user interface 102 compares a number of line items or associated allocated resource to a threshold to determine which of the descriptors 128 are presented according to the current view.

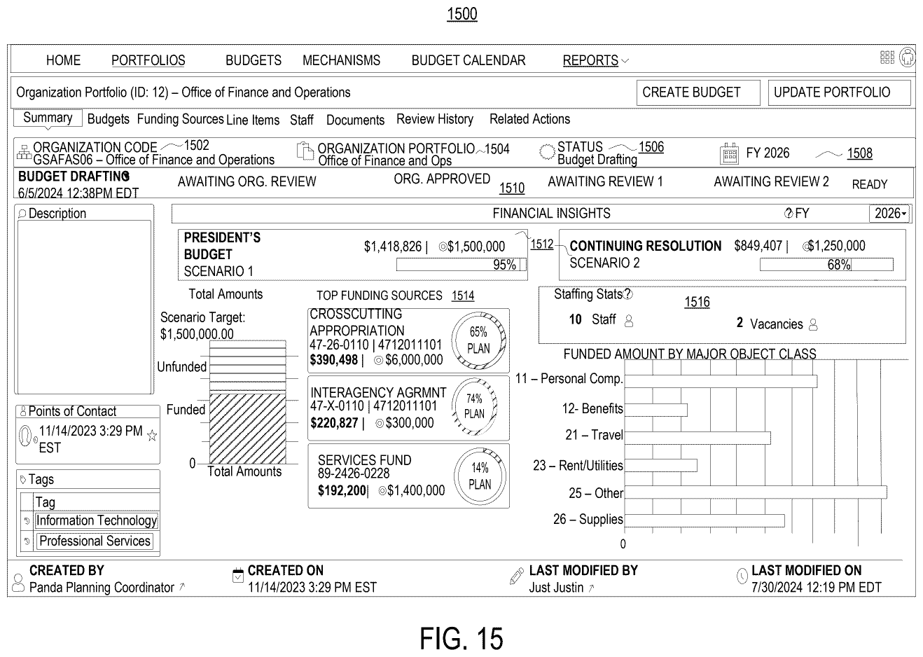

According to a planning view, a planned percentage 1414 of resources can be provided, relative to a target. In other views, other indications of organizational activities may be provided (e.g., an expended portion or received portion). Expenditures to various classes or categories are provided according to a further display element 1416. Another display element 1418 indicates various resource allocation datasets 122 as may be used to compare various budgets, scenarios, and so forth. Such resource allocations may be selected according to various criteria, such as the rank-sorting or threshold above, or according to a portion of unallocated resources, to aid in the drafting process. In some embodiments, a selection of the depicted resource allocations are provided according to a user selection according to a further instance of the user interface 102. In some embodiments, the various resource allocation datasets 122 may be selectable from the current view. For example, user interface 102 can present the GUI 1500 of FIG. 15 responsive to a selection of one of the resource allocation datasets 122.

FIG. 15 is another example instance of a GUI 1500 depicting a report as associated with a tag or other descriptor 128, according to some embodiments. Particularly, the report can refer to a selection of a single budget or other resource allocation datasets 122. A first indication 1502 (e.g., display element) can present an indication of an organization, as may be a same, constituent, or other organization, relative to the view of FIG. 14. A second indication 1504 (e.g., display element) can provide further organizational detail, as in the case of a constituent organization. A third indication 1506 can indicate a status, and further reference information including a contact may be presented, as discussed with regard to the GUI 1400 of FIG. 14. Such reference information can include an indication 1508 of a fiscal year or other period. Routing information 1510 can indicate an approval or execution status, and constituent elements thereof may be selectable to determine a point of contact, approver, approval time, pendant time, or so forth.

One or more scenarios may be presented according to the present example GUI 1500 (e.g., according to a scenario control element 1512), or a scenario may be otherwise selectable via the user interface 102. The GUI 1500 can further indicate funding sources 1514 and funding sinks 1516, such as contracts, personal, operational or capitol expenses, and so forth. Further, as described with regards to the prior example GUI 1400, associated tags 1518 are presented. In some embodiments, such tags 1518 may be selectable to modulate the present view (e.g., to provide data relating to all or a subset of tags 1518 associated with a selected resource allocation dataset 122 or scenario thereof).

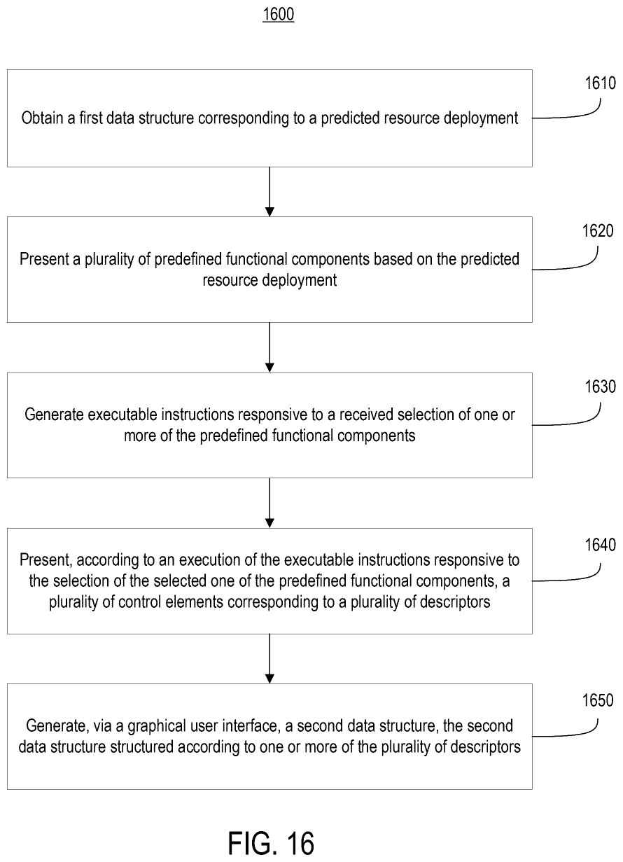

FIG. 16 is an example flow diagram for a method 1600 for the automatic generation of computer-executable code, according to some embodiments. The method 1600 can be performed by one or more systems or components depicted in the present disclosure, as may include one or more processors coupled with memory or other non-transitory computer readable storage media, an example of which is provided henceforth with regard to FIG. 17. For example, an illustrative example of such a data processing system 101 is depicted in FIG. 1 and described throughout the present disclosure. Although certain operations are described according to the present method 1600, the method can include additional, fewer, or different operations according to various embodiments, some examples of which are described throughout the present disclosure.

At operation 1610, the data processing system 101 obtains a first data structure corresponding to a predicted resource deployment. For example, the first data structure can include a utilization schedule for computational resources, power budget for thermal-constrained processing units, latency budget for inter-process communication across distributed nodes, annual budget, or other indication of a predicted deployment of a resource. The receipt of the items of the data structure can include receiving data elements of the first data structure, via one or more application programming interfaces (APIs), from various sources. The API can include, for example, a REST API or a simple object access protocol (SOAP) API. The prediction can relate to one or more years, quarters, processing cycles, or other periods of time. For example, the predicted resource deployment comprises a first prediction corresponding to a current temporal period and a second prediction corresponding to a subsequent temporal period.

The predicted resource deployment can include predictions for various levels of a hierarchical structure. For example, the predicted resource deployment can include a use of a first, second, or third level of a memory cache, or an agency 202, and one or more tiers of constituent organizations 204. The data processing system 101 can generate a graphical depiction of resources deployed corresponding to the descriptors described herein. Further, the data processing system 101 can generate a data map to correlate data elements of various levels of a hierarchical structure, the data map configured to maintain coherency between one or more metrics between the levels.

At operation 1620, the data processing system 101 presents various predefined functional components based on the predicted resource deployment. For example, the predefined functional components can include logical blocks of a no-code/low-code environment configured to provide logical flows of data corresponding to a codebase. At operation 1630, the data processing system 101 generates executable instructions responsive to a received selection of one or more of the predefined functional components. For example, the generation of the code can include generating code to update a codebase, as described throughout the present disclosure.

At operation 1640, the data processing system 101 presents, according to an execution of the executable instructions responsive to the selection of the selected one of the predefined functional components, various control elements corresponding to multiple descriptors. For example, the descriptors can include various tags provided by a user to indicate an association of the allocated resource with various relationships not included in the prediction of operation 1610.

At operation 1650, the data processing system 101 generates, via a graphical user interface, a second data structure, the second data structure structured according to one or more of the plurality of descriptors. The second data structure can include or depend on a comparison, performed by the data processing system, of the predicted resource deployment with a current state of deployed resources to generate harmonization data. The harmonization can refer to or include harmonizing the predicted resource deployment based on one of a continuing resolution, sequestration, or other adjustment to a predicted resource deployment for a current or future temporal period.

FIG. 17 is a block diagram illustrating an architecture for a computer system 1700 that can be employed to implement elements of the systems and methods described and illustrated herein. The computer system 1700 or computing device can include or be used to implement the controller 108 or its components, and components of the systems provided herein, including one or more processors coupled with a memory or other non-transitory computer readable storage media. The computing system 1700 includes at least one bus 1705 or other communication component for communicating information and at least one processor 1710 or processing circuit coupled with the bus 1705 for processing information. The computing system 1700 can also include one or more processors 1710 or processing circuits coupled with the bus for processing information. The computing system 1700 also includes at least one main memory 1715, such as a random-access memory (RAM) or other dynamic storage device, coupled with the bus 1705 for storing information, and instructions to be executed by the processor 1710. The main memory 1715 can be used for storing information during execution of instructions by the processor 1710. The computing system 1700 can further include at least one read only memory (ROM) 1720 or other static storage device coupled with the bus 1705 for storing static information and instructions for the processor 1710. A storage device 1725, such as a solid-state device, magnetic disk or optical disk, can be coupled with the bus 1705 to persistently store information and instructions (e.g., for the data repository 120).

The computing system 1700 can be coupled via the bus 1705 to a display 1735, such as a liquid crystal display, or active-matrix display. An input device 1730, such as a keyboard or mouse can be coupled with the bus 1705 for communicating information and commands to the processor 1710. The input device 1730 can include a touch screen display 1735.

The processes, systems and methods described herein can be implemented by the computing system 1700 in response to the processor 1710 executing an arrangement of instructions contained in main memory 1715. Such instructions can be read into main memory 1715 from another computer-readable medium, such as the storage device 1725. Execution of the arrangement of instructions contained in main memory 1715 causes the computing system 1700 to perform the illustrative processes described herein. One or more processors in a multi-processing arrangement can also be employed to execute the instructions contained in main memory 1715. Hard-wired circuitry can be used in place of or in combination with software instructions together with the systems and methods described herein. Systems and methods described herein are not limited to any specific combination of hardware circuitry and software.

Although an example computing system has been described in FIG. 17, the subject matter including the operations described in this specification can be implemented in other types of digital electronic circuitry, or in computer software, firmware, or hardware, including the structures disclosed in this specification and their structural equivalents, or in combinations of one or more of them.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims. For example, according to some implementations, the various user interface instances of the present disclosure may include configurable control elements as may be selected to display a subset of elements as may be useful for a particular use case.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware may be designed to implement the systems and methods based on the description herein.

When implemented in software, the functions may be stored as one or more instructions or code on a non-transitory computer readable or processor readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for automatic generation of computer-executable code, the method comprising:
obtaining, by a computer, a first data structure corresponding to a predicted resource deployment;
presenting, by the computer, a plurality of predefined functional components based on the predicted resource deployment;
generating, by the computer, executable instructions responsive to a received selection of one or more of the predefined functional components;
presenting, by the computer, according to an execution of the executable instructions responsive to the selection of the selected one of the predefined functional components, a plurality of control elements corresponding to a plurality of descriptors; and
generating, by the computer via a graphical user interface, a second data structure, the second data structure structured according to one or more of the plurality of descriptors.

2. The computer-implemented method of claim 1, wherein the predicted resource deployment comprises a first prediction corresponding to a current temporal period and a second prediction corresponding to a subsequent temporal period.

3. The computer-implemented method of claim 2, further comprising comparing, by the computer, the predicted resource deployment with a current state of deployed resources to generate harmonization data.

4. The computer-implemented method of claim 1, wherein the predicted resource deployment corresponds to a hierarchical structure comprising a plurality of levels, wherein each of lower levels of the plurality of levels are aggregated at progressively higher levels of the hierarchical structure.

5. The computer-implemented method of claim 4, further comprising generating, by the computer, a data map to correlate data elements of various levels of a hierarchical structure, the data map configured to maintain coherency between one or more metrics between the plurality of levels.

6. The computer-implemented method of claim 1, further comprising retrieving, by the computer, from a plurality of sources, data elements of the first data structure, via one or more application programming interfaces (APIs).

7. The computer-implemented method of claim 6, wherein an API of the one or more APIs includes a REST API or a simple object access protocol API.

8. The computer-implemented method of claim 1, further comprising harmonizing, by the computer, the predicted resource deployment based on one of a continuing resolution, sequestration, or other adjustment to a predicted resource deployment for a current or future temporal period.

9. The computer-implemented method of claim 1, further comprising generating, by the computer, a graphical depiction of resources deployed corresponding to the descriptors.

10. A computing system for automatic generation of computer-executable code, the system comprising:
one or more processors configured to:
obtain a first data structure corresponding to a predicted resource deployment and a token providing an identity of a first user;
present a subset of a plurality of predefined functional components of a no-code or low-code program based on the predicted resource deployment and an access level associated with the first user identity;
generate executable instructions responsive to a received selection of one or more of the subset of the predefined functional components of the no-code or low-code program;
present, according to an execution of the executable instructions responsive to the selection of the selected one of the predefined functional components, a plurality of control elements corresponding to a plurality of descriptors;
generate a second data structure, the second data structure structured according to one or more of the plurality of descriptors; and
generate a graphical user interface (GUI) the second data structure for display to a plurality of second users based on a receipt of corresponding tokens for the second users, in response to identifying a first hierarchical level of the first user relative to a second hierarchical level of the plurality of second users.

11. The computing system of claim 10, wherein the predicted resource deployment comprises a first prediction corresponding to a current temporal period and a second prediction corresponding to a subsequent temporal period.

12. The computing system of claim 11, wherein the one or more processors are configured to:
compare the predicted resource deployment with a current state of deployed resources to generate harmonization data.

13. The computing system of claim 10, wherein the predicted resource deployment corresponds to a hierarchical structure comprising a plurality of levels, wherein each of lower levels of the plurality of levels are aggregated at progressively higher levels of the hierarchical structure.

14. The computing system of claim 13, wherein the one or more processors are configured to:
generate a data map to correlate data elements of various levels of a hierarchical structure, the data map configured to maintain coherency between one or more metrics between the plurality of levels.

15. The computing system of claim 10, wherein the one or more processors are configured to:
retrieve, from a plurality of sources, data elements of the first data structure, via one or more application programming interfaces (APIs).

16. The computing system of claim 15, wherein an API of the one or more APIs includes a REST API or a simple object access protocol API.

17. The computing system of claim 10, wherein the one or more processors are configured to:
harmonize the predicted resource deployment based on one of a continuing resolution, sequestration, or other adjustment to a predicted resource deployment for a current or future temporal period.

18. The computing system of claim 10, wherein the one or more processors are configured to:
generate a graphical depiction of resources deployed corresponding to the descriptors.

19. A non-transitory computer readable medium comprising instructions for automatic generation of computer-executable code that, when executed by at least one processor, are configured to cause the at least one processor to:
obtain a first data structure corresponding to a predicted resource deployment;
present a plurality of predefined functional components based on the predicted resource deployment;
generate executable instructions responsive to a received selection of one or more of the predefined functional components;
present, according to an execution of the executable instructions responsive to the selection of the selected one of the predefined functional components, a plurality of control elements corresponding to a plurality of descriptors; and
generate, via a graphical user interface (GUI), a second data structure structured according to one or more of the plurality of descriptors.

20. The non-transitory computer readable medium of claim 19, comprising instructions to:
compare the predicted resource deployment with a current state of deployed resources to generate harmonization data, wherein the predicted resource deployment comprises a first prediction corresponding to a current temporal period and a second prediction corresponding to a subsequent temporal period.
